(19) United States
(12) Patent Application Publication
(10) Pub. No.: US 2019/0108738 A1
(43) Pub. Date: Apr. 11, 2019

(54) METHOD AND APPARATUS FOR PROVIDING EARLY WARNING OF HAZARDOUS CONDITIONS THAT MAY CAUSE FIRES

(71) Applicant: Micro Automation Industries, Dubai (AE)

(72) Inventor: Hazim Makki AL HAJJAJ, Dubai (AE)

(73) Assignee: Micro Automation Industries, Dubai (AE)

(21) Appl. No.: 16/149,772

(22) Filed: Oct. 2, 2018

Related U.S. Application Data
(60) Provisional application No. 62/566,585, filed on Oct. 2, 2017.

(51) Int. Cl. G08B 17/06; G08B 17/12

(52) U.S. Cl. CPC G08B 17/06; H02H 1/0015; G08B 17/12

(57) ABSTRACT

Embodiments disclosed herein include a compact wireless network-based monitoring device that can be placed inside an electrical connection box without an elaborate installation process to trigger a warning when there are dangerous conditions in the electrical wirings and installations. For example, the temperature or relative humidity are measured, and compared with a set of limits to send a warning message wirelessly. Many other conditions can be sensed and measures, such as levels of oxygen or various gases. If conditions are outside preset set limits, messages are sent to a gateway connected to the internet and/or to smart devices.

### RELATED APPLICATION INFORMATION

This application claims priority from U.S. Provisional Patent Application No. 62/566,585, filed Oct. 2, 2017, which is incorporated by reference in its entirety herein.

### FIELD OF THE INVENTION

Inventions disclosed herein are in the field of providing early warning of electrical faults that may cause fires, particularly in large commercial or residential buildings and buildings with distributed systems.

### BACKGROUND

The company UL (see UL.com) has determined that fire's today are more dangerous and pose more risks than in the past. Fire propagation is faster, and time to flashover, escape times and collapse times are all shorter. The “legacy room”—a room using materials from the 1970s takes nearly 30 minutes to get to the “flashover” point where it's fully engulfed. The “modern room”—a room using modern material hits that point in less than four minutes. Most of fire accidents in residential and office buildings are the result of electrical faults associated with wiring or wiring devices in single phase distribution systems. Therefore, there is a need for a system that provides early warning of possible fire hazards in modern buildings and building complexes. There is also a need for a system that provides enough warning that there is time to identify and repair root causes of incidents (such as fires) before they occur.

The conventional fire alarm sensors that are usually installed on the ceiling will trigger an alarm signal after detecting infrared or smoke or a high rate of heat rise. Typically there is no affordable device that can monitor the electrical box or connection point; and give an early warning of a hazard prior to the actual occurrence. Thus, there is a need to supply a fire alarm system that monitors causes of fire rather than the fire itself.

### BRIEF DESCRIPTION OF THE DRAWINGS

FIG. 1 is a block diagram of an electrical wiring monitoring system according to an embodiment.

FIG. 2 is a flowchart illustrating the operation of a monitor node (capsule) according to an embodiment.

FIG. 3A is an illustration of a monitor capsule according to an embodiment.

FIG. 3B: is an illustration of a monitor capsule installed inside an electrical connection box.

FIG. 3C: 3C-1, 3C-2, 3C-3 and 3C-4 are illustrations of electrical sockets with embedded monitoring mechanisms according to embodiments that provide power cut functions and loose connection protection.

FIG. 4 includes diagrams of a wall socket outlet and a wall socket cover plate with built-in pre fire alarm sensor (prefa).

FIG. 5 is a diagram of a commercial building application for the prefa sensor.

FIG. 6 is an illustration of a prefa sensor and a coin battery according to an embodiment.

FIG. 7 is a diagram of a smart city network using pre-fire alert (prefa).

### DETAILED DESCRIPTION

As disclosed herein, a system for early fire or pre-fire (also referred to herein as prefa) detection using distributed sensors is described. Compact sensors with long battery life are networked in a location, and also potentially anywhere via the internet to provide early warning of potentially harmful events.

In an embodiment, the system consists of, a low power microcontroller unit (MCU), a coin cell, or similar, battery, a combined humidity and temperature sensor, and a wireless transceiver. At a programmable interval (one measurement per 4 second for example), and when the MCU has finished reading and transmitting the sensor data, a signal to the system causes the MCU to enter sleep mode. By duty-cycling the entire system in this manner, the design achieves more than ten years of battery life from a coin cell.

In various embodiments, power to sensors is arranged through different methods. A coin size battery that can last for 5-7 years. Power can be arranged by clamp-on the side screws of an electrical socket when a prefa wall socket cover plate is used. No batter is required in this case. This will offer longer life time than arrangement with coin size battery. Power can be arranged by energy harvesting of the power propagated from the electrical wires carrying power. The harvesting is done by pick up the electromagnetic energy generated by existing of electrical power. Connecting a prefa sensor to electrical power in the socket outlet is a way to avoid using battery for prefa operation. This eliminates the safety precautions involved with using a battery.

Embodiments disclosed herein include a compact wireless network-based (typically thumb-sized) micro-sensor monitoring device that can be placed inside an electrical connection box without an elaborate installation process to trigger a warning when there are dangerous conditions in the electrical wirings and installations. The temperature or relative humidity are measured, and compared with a set of limits to send a warning message wirelessly. If conditions are outside the set limits, messages are sent to a gateway connected to the internet and/or to smart devices. If the temperature inside an electrical junction box exceeds a set value (80 C for example) that indicates an abnormal situation that should be immediately investigated. In a similar scenario, excessive humidity will trigger messages to be sent. In addition, sample readings will be send to a gateway at predetermined times to check functionality of the device and to predict over several readings a danger scenario that will need investigating, for example a slow increase of humidity inside the box.

Many fire accidents happens due to an electrical short circuit or loose connection in the electrical wiring, Monitoring the temperature and the humidity inside an electrical connection compartment, such as a junction box or connection box, provides an early warning about fire if the temperature rises beyond a maximum expected level of temperature or relative humidity.

In embodiments, the monitoring device is designed to be small, and battery operated. There is no need for custom installation work or connection to power or control wiring. Significantly, the device is small enough to be easily placed inside the electrical connection box. This ensures early sensing for fire in its early stages rather than the sending fire notifications through existing fire sensors, which usually are typically installed at the roof of the building. Embodiments of the device monitor the environment inside an electrical connection compartment (“the box”) to predict a fire incident, a short circuit that might lead to power cut, or an accident that leads to damage in electrical wirings in residential buildings or office buildings.

The box, in an embodiment, is a closed compartment. This makes monitoring of the atmosphere inside the box very effective, and the electronic components and software that make up the box can quickly sense any unusual status of electrical wiring/installations. Monitoring the temperature inside the box gives an early warning of possible dangerous conditions in/around electrical wiring/installation that require immediate action for repair or maintenance. Moreover, monitoring the humidity inside the box allows for an early warning of dangerous conditions that might result in a short circuit for which a repair call is required.

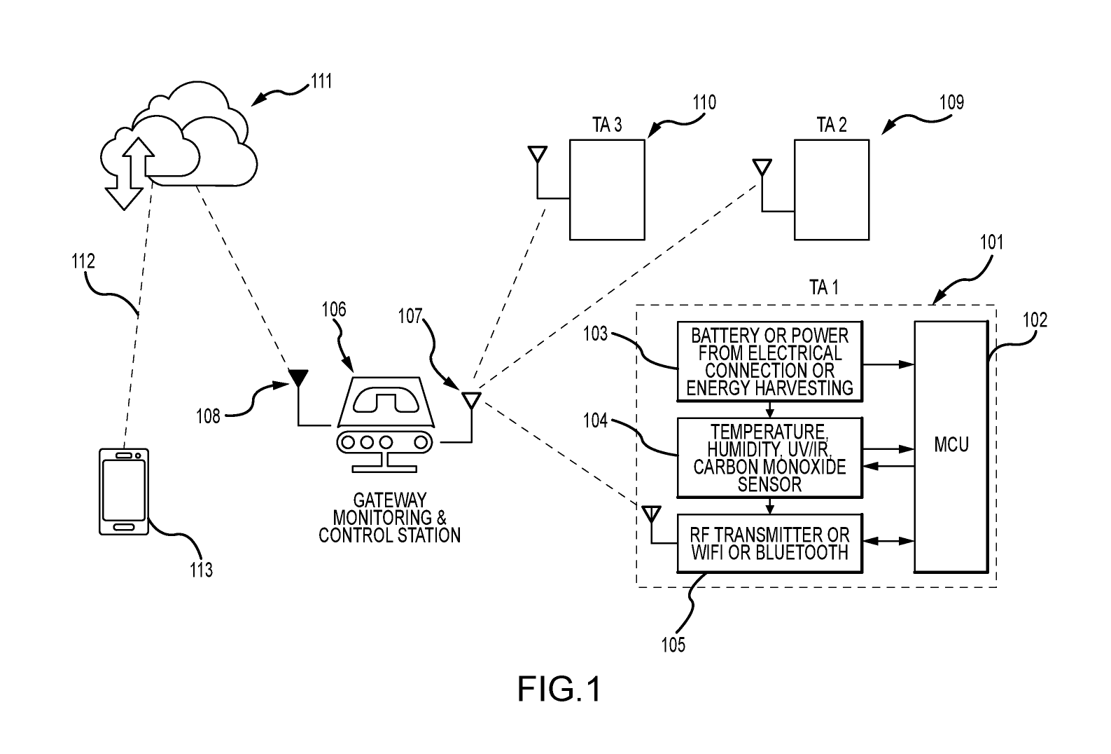

FIG. 1 is a block diagram of an electrical wiring monitoring system according to an embodiment. As an overview, the system consists of a communication system that connects prefa sensors, through cloud server, to a web or Android or Apple application installed in a smart device (such as a smart phone, tablet . . . etc.) as shown in the drawing. A system application receives data packets from the gateway and stores them in a cloud database. The application also sends data to smart devices when an update is required for the embedded algorithm software. The system also receives setting commands from smart devices and sends them to the gateway.

The application installed in smart devices enables users to check data of sensors connected to the gateway and displayed to user, check configuration of the gateway, send settings to sensors, and provide analysis for sensors history. An installation application includes configuration of the gateway through network cable (for example, between a PC and the gateway). Configuration of sensors includes adding new sensors through a unique sensor ID, remove existing nodes, and defining the gateway-to-cloud server.

The system includes a gateway 106 as further described below. RF Transceiver 105, in an embodiment, is an RF modulator equipped with an antenna used to communicate with local RF gateway.

Microcontroller (MCU) 102 acts as the intelligent heart of the device. MCU 102 controls the operation of the device, and transmits information to the gateway or central location for processing. However, because power consumption is always a concern in battery-based applications, the processor must be low power. The MCU enables extremely long battery life for the sensor using the internal timer of the microcontroller to go on sleep mode or using a nano-power timer either to bring an MCU out of sleep mode by means of a pin interrupt, or to completely shut off power to the system, in whole, or in part to reduces the off-state current drawn from the battery to the tens and hundreds of Nano amps. The timer interval ranges from few millisecond up to hour in an embodiment. The Nano power timer device is also used to control a low leakage analog switch, that shuts off power to the entire system. An important characteristic of this switch is the very low off-state leakage, because that leakage will affect the overall battery life of the system significantly.

Lithium Coin Battery 103 is the power source used in an embodiment. The selection of coin cell battery as the power source was due to the ubiquity of that battery type, particularly in small form factor systems, such as a sensor end node. The voltage characteristics of a lithium-ion (like CR2032 coin cell battery) are ideal. The output voltage remains relatively flat throughout the discharge life, until the cell is nearly depleted. At that time, the output voltage drops off relatively quickly. The temperature characteristics of lithium-ion batteries are also superior to that of alkaline cells. The lithium-ion cells have a non-aqueous electrolyte that performs better than aqueous electrolytes commonly found in alkaline batteries. Immediately following the battery is a low forward voltage Schottky diode, a current limiting resistor, and a bulk capacitor. The Schottky diode prevents damage to the hardware if the coin cell battery is inserted backwards. The current limiting resistor in conjunction with the bulk capacitor reduces the current spikes drawn from the battery when the system transitions from off-state to on-state. The bulk capacitor is also sized to prevent too much voltage from being dropped across the current limiting resistor during the on state.

Sensor 104 can include any sensor for sensing one or more environmental factors, including but not limited to temperature, humidity, ultra violet (UV)/infrared (IR), and carbon monoxide. Minor sparks that occur prior to a fire or when a fire is about to start have a strong IF or UV light footprint. UV light is a sign of spark whereas IR light is a sign of fire. If these elements occur within an enclosed electrical outlet or electrical connection box or any enclosed environment, sensing of these phenomena gives early indication of conditions that lead to a fire incidents. Adding UV and IR sensing capability to a prefa node allows it to sense these effects. In embodiments, the prefa node able to sense light through its exposure to it, relying on the strength of light illumination (Lux).

In an embodiment a method to adapt low power sensing for gases through utilizes Nano technologies (e.g., printed electronics) to reduce prefa node circuit size if a normal gas sensor is used. Carbon Monoxide gas sensing is added within the prefa node; making it able to sense gases arises from burning electrical materials like wires. The utilization of nano technology and printed electronics allow prefa nodes to have minimal size and yet have the ability to fit it into different types of power outlets (sockets, sockets cover plate and connection box etc.) or cabinets (Data cabinets, communication racks, etc.)

A prefa node warns and delivers information through the right channel, and transmits data to a gateway, to the cloud, and then displays the information on a prefa system or personnel smart device. A smart algorithm is embedded inside prefa nodes. When the node detects (through its sensors) pre-fire conditions within a power outlet or cabinet or closed environment; it starts a warning process that covers a notification or message shared with any connected apparatus (internet connected devices example: phone, computer, building management system, etc.) The notification or message will be shared based on pre-setting as per the prefa user and in many cases it can be connected to nearby fire department to dispatch a team in case of a fire.

In an embodiment, a prefa has its own smart device and computer application to allow users to view information delivered from the prefa nodes and analyzed through the cloud for alerts or notifications. Moreover, a prefa system application gives users the ability to pre-set the preview preferences and gives the ability to customize data. In an embodiment, the prefa application has third-party application integrations allowing for more flexible deployment.

A prefa can also be used as a fire sensor, and can be a complement to traditional fire sensors since it can still act as a fire sensor. Having the ability to sense rate of heat rise, temperature level, rate of humidity rise which is part of traditional fire system, the prefa system can act as a system to eliminate false fire alarms such as often happen in a traditional fire warning/alarm system.

There are many conditions that can lead to a fire incident. The conditions might be low risk, medium, high, or dangerous level. The criteria that will lead to a fire incident can include one or more parameters. These parameters vary from rate of Temp rise, high temperature, rate of humidity rise, humidity level, infrared, UV light, carbon monoxide and various interconnected relations between two or more parameters. The prefa sensor and system establishes multiple relationships between those parameters. For example, Low Humidity level (Dry environment) can lead to a fire incident if accompanied with certain temperature level, whereas high humidity level might also lead to a fire incidents regardless of temperature level.

The sensor used in an embodiment is a digital humidity sensor with integrated temperature sensor that provides excellent measurement accuracy at very low power. An HDC1010 combined sensor (as an example) operates over a wide supply range, and is low cost. The sensor package simplifies board design with the use of an ultra-compact package. The sensing element of the HDC1010 is placed on the bottom part of the device, which makes the sensor more robust against dirt, dust, and other environmental contaminants. The humidity and temperature sensors are factory calibrated and the calibration data is stored in the on-chip nonvolatile memory.

Gateway 106 is an embedded unit in an embodiment (using for example Raspberry Pi). It contains: RF transceiver function 107 to communicate and receive data from the monitoring devices 101, 109, 110, WiFi function 108 to communicate with the cloud server 111, memory to store data locally, touch screen Display to control and setting up the system, GSM connecting facility to send messages in case of danger, reset/scan function,

Referring to Wireless Network 107: Because the power is cut off from the wireless transceiver 105, a star network configuration is used in an embodiment. This means that each sensor end-node connects directly to a control Station (Gateway) 106 which receives the data from each end-node, and then performs any necessary processing and connection to the cloud. This implies that the design is not intended for use in smart mesh networks, because the wireless transceiver will not retain its state or have any control over when it wakes up.

The devices 101, 109, 110 send out data packets that contain four bytes of data: two bytes of temperature data and two bytes of relative humidity data. This data is transmitted directly as the sensor device outputs it; no post-processing or correction is implemented on the MCU itself. The antenna is the small size antenna.

Firmware Control

The firmware is developed for Wireless transceiver based on internal packet handling and error checking firmware of the transceiver. Additional 1 byte of checksum is transmitted with the packet for error checking of the Gateway. The firmware contains the driver for the sensor in order to communicate with the sensor. The packet contains also the IDs corresponding to the sensor, Gateway and the 4 byte data of the sensor data.

After the packet of the sensor data sent the MCU programmed to wait for acknowledgment packet from the Gateway to ensure the reception. The firmware will repeat sending the data packet until acknowledgment received.

Power Consumption:

The power topology for the battery-powered wireless sensor end-nodes is the power consumption as it is critical in making the innovation practical. There are two states: on-state and off-state. Both the duration and the average current of each state are factors in estimating the total battery life of the device.

The on-state current consists of the current of MCU, wireless transceiver, sensor, communicate with the sensor device, receives the temperature and relative humidity information, transmits data packet. The off-state consists of the sleep mode current of the MCU. The consumptions from the coin cell battery are the recharging and leakage currents due to the bulk capacitor near the coin cell,

Estimated Battery Life Calculations

for estimating battery life of the TI Design system, has five parameters:
Capacity rating of the battery in milliamp-hours (mAh)
Average off-state current consumption (nA)
Off-state duration (s)
Average on-state current consumption (mA)
On-state duration (s)

The battery used is Lithium-ion coin cell, which has a capacity rating of 240 mAh. There is a built-in de-rating factor of 85%, which attempts to model the effects of varying temperatures, as well as battery self-leakage. When using the measured values for the remaining parameters, the battery life is calculated.

Radio Transmission Range

A brief transmission range test was performed with the hardware to get a rough approximation of transmission range of 100 meter. The test was done inside a commercial office building, The hardware placed inside a wiring connection box at one end of the Building. There were 2 wall as obstacles during the test. The test is to find if the data packet successfully receivable. The test device was able to successfully transmit data packets down the entire length of a 100 meter with minimal obstructions. However, radio performance will likely vary in the end-equipment environment, because obstructions in the RF transmit path will reduce range. For full verification further testing with end-equipment context is required.

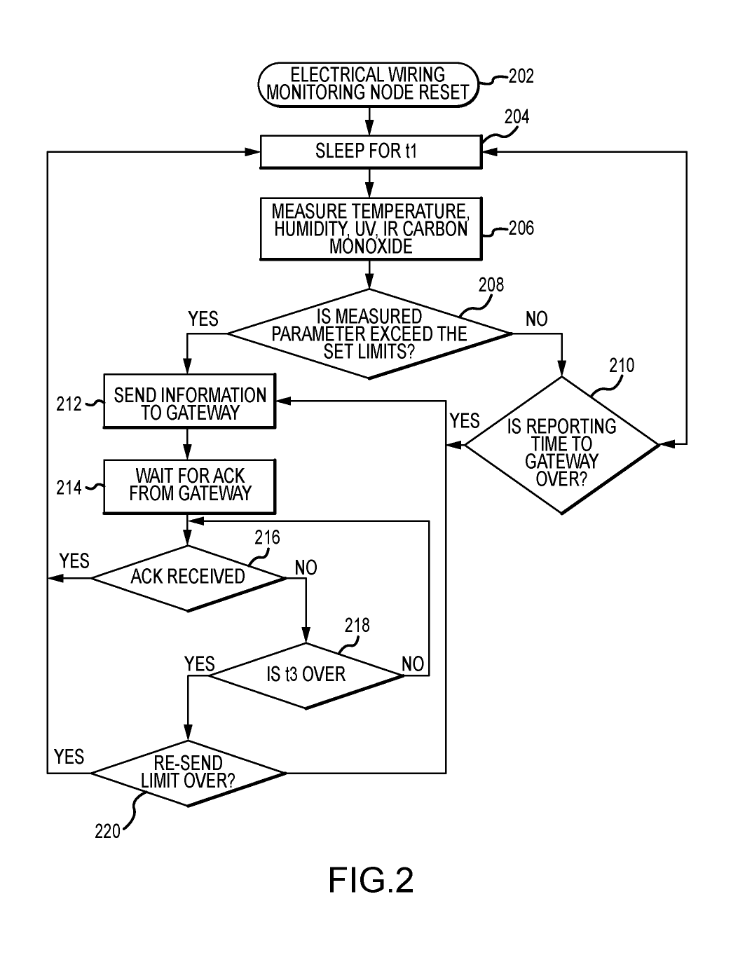

FIG. 2 is a flowchart describing the function of a monitor node (capsule) according to an embodiment. The monitor node (capsule) provides early warning of electrical faults associated with wiring in a distributed system.

At 202, the node is reset or initially set. At 204 a sleep interval is programmed to occur for a preset time t1. at 206 the node measures the temperature, humidity, ultraviolet (UV), infra-red (IR, and carbon monoxide levels.

At 208 it is determined whether a measured parameter exceeds preset limits. If the a measured parameter exceeds preset limits, the relevant information is sent to a gateway at 212, and the system waits for an acknowledgement from the gateway at 214. When the acknowledgement is received (216), the system returns to sleep mode (204) and also determines whether a re-send limit has been exceeded (220). If the re-send limit is not exceeded, the process returns to 212 to send information to the gateway.

If the acknowledgement is not received (216), it is determined whether a predetermined time t3 has been exceeded, and if so, the process goes to 220 to determine whether the re-send limit has been exceeded. If time t3 has not been exceeded, the process returns to 216 to check for receipt of the acknowledgement.

Returning to 208, if the measured parameter does not exceed the set time limits, it is determined at 210 whether a time for reporting the gateway is over. If this time is over, the process returns to 212.

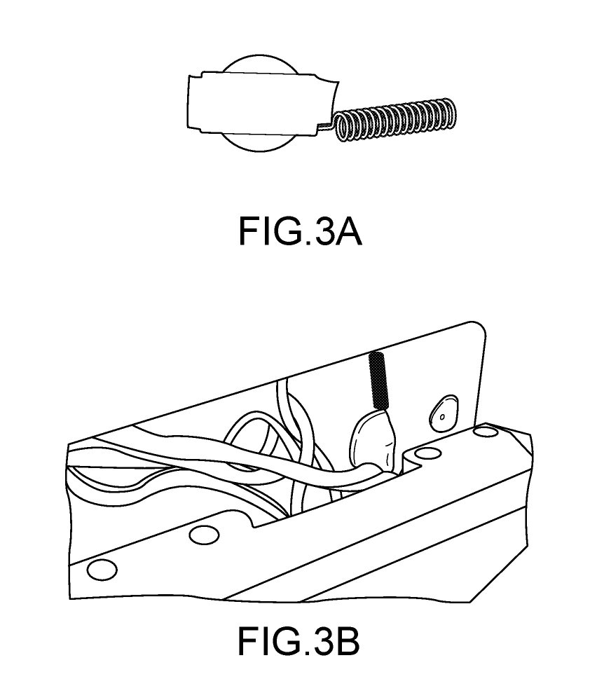

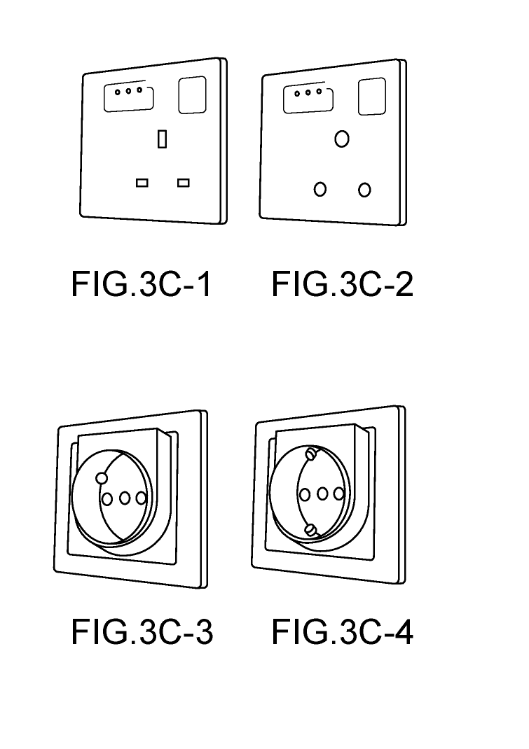

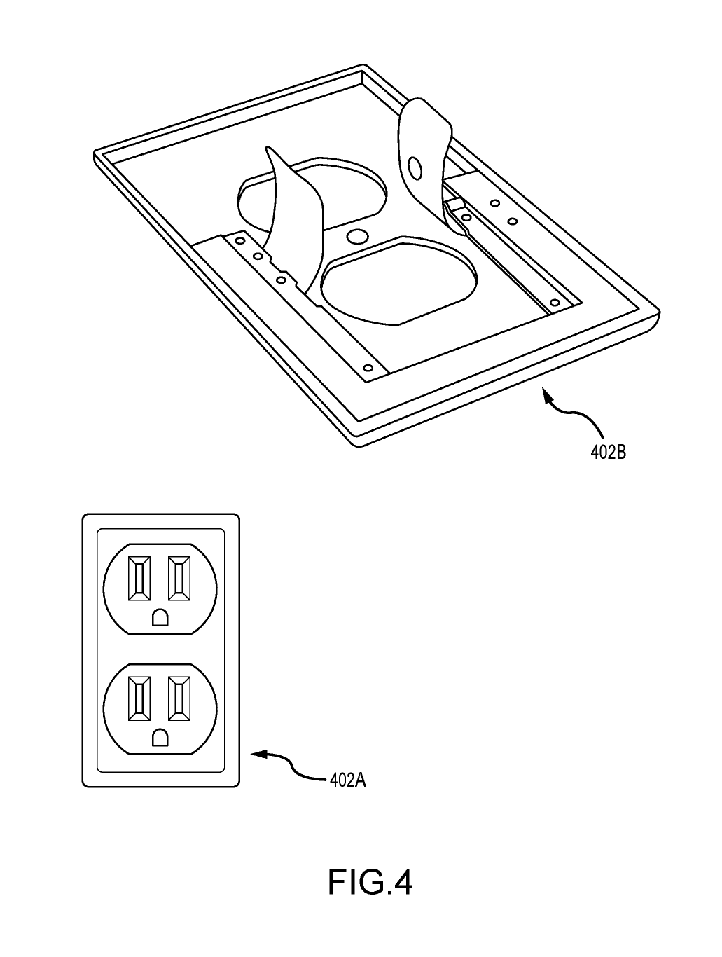

FIG. 3A is a diagram of a monitor capsule according to an embodiment. The monitor capsule is compact and can be placed in small spaces such as the connection box illustrated in FIG. 3B, which shows the monitor capsule inside a connection box.

FIG. 3C: is a diagram of various electrical sockets A, B, C, and D, each with an embedded monitoring mechanism including power cut function and loose connection protection.

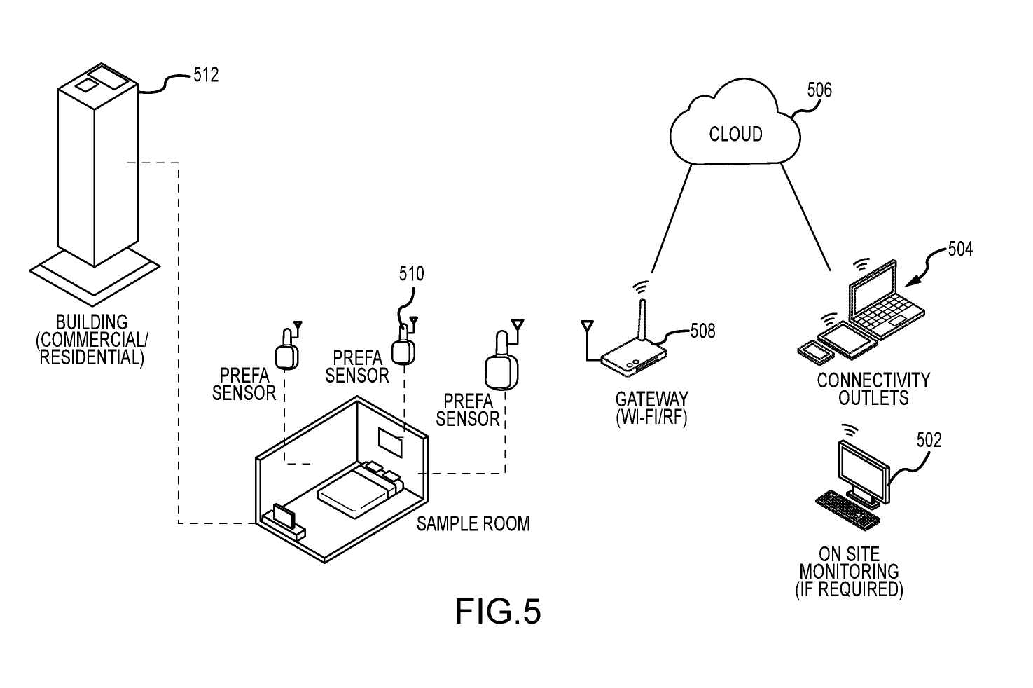

FIG. 4 shows both a socket outlet 402A with a prefa sensor (not shown), and a wall socket cover plate that can accommodate a built-in prefa sensor. This deployment method allows the use of the space within a wall socket cover plate to install a prefa nodes while maintain its sensing abilities.

The space available on the backside of a wall socket cover plate is used to embed prefa node components. The circuit is covered with a shield to keep the node hardware protected during handling and installation. An opening is provided in the element cover to have access to an installation rest button, also provided is a small window for sensing air temperature or other sensing factors. By this method, power is provided to the node by connecting to the electrical socket itself. The cover plate is designed to offer a consumer a Do-it-Yourself solution. It is easily installed by removing an existing socket cover and fixing a prefa socket cover instead. The electrical connection will be made with the wall socket once the socket cover is fixed. The two fixtures fixed on the cover plate make the electrical connection through the socket screws (screws where wires are connected to the socket outlet).

FIG. 5 is a diagram of a deployment of a prefa sensor in a commercial building system. The commercial building 512 includes multiple prefa sensors. In a sample room of the building, for example, there are three prefa sensors installed. Through a communication gateway such as gateway 508, the prefa sensors communicate with the cloud (or internet) 506. Connectivity outlets 504 and on site monitoring 502 include any devices that are capable of receiving signals form the gateway 508 through the cloud 506.

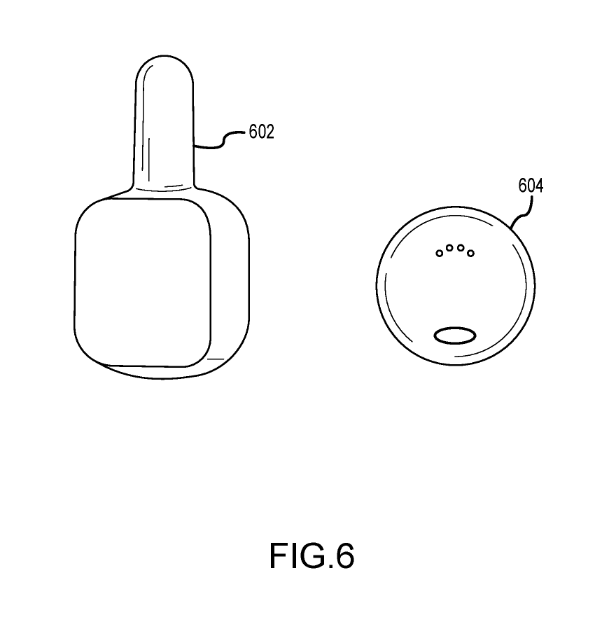

FIG. 6 illustrates a prefa sensor 602 according to an embodiment, and a coin battery 604 that is sufficient to power the prefa sensor 602.

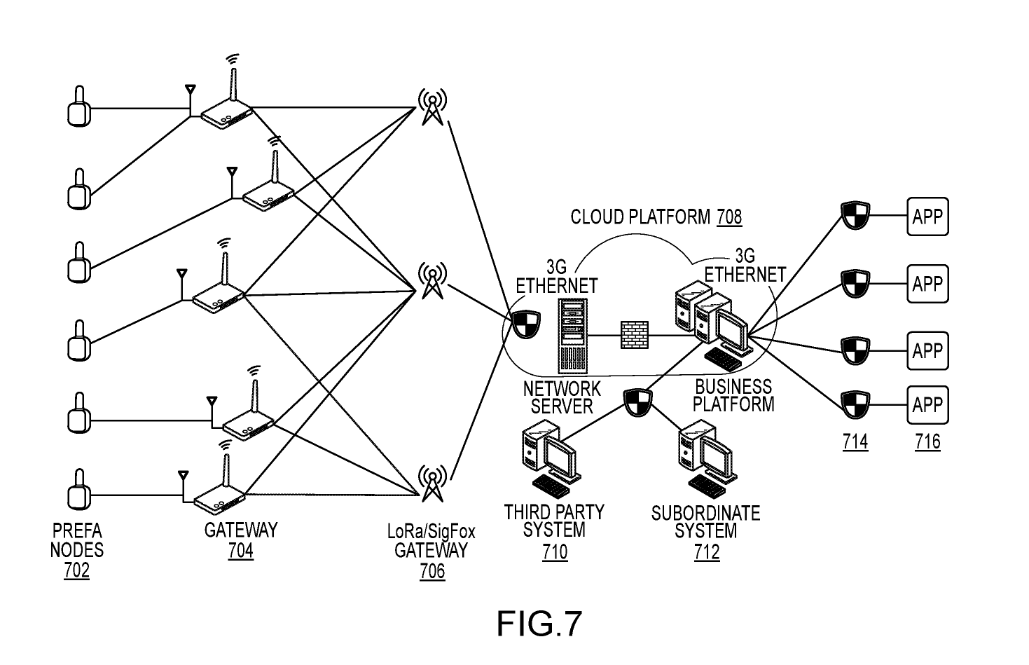

FIG. 7 is a diagram of a smart city application using the prefa sensor. Multiple prefa sensor nodes 702 can exist anywhere within the city. The prefa nodes 702 communicate through gateway layer 704 and gateways 706 to a cloud platform, 708. The cloud platform 708 includes, in one embodiment, a 3G Ethernet interface, one or more network servers, a firewall and a business platform. The business platform is configured to receive data from the prefa sensors, process the data so as to provide user-friendly information as required, an transmit the information to multiple apps (applications) 716 through a security layer 714.

The information can also be distributed from the business platform through a security layer to third party system(s) 710 and superordinate system(s) 712 as desired.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A system for early hazardous condition detection, the system comprising:
one or more sensors comprising a temperature sensor, a UV/IR sensor, and a carbon monoxide sensor;
a communication transmitter coupled to the one or more sensors to receive sensor values from the one or more sensors; and
a microcontroller unit (MCU) coupled to the one or more sensor and to the communication transmitter, wherein the MCU is configurable to: process sensor values from the one or more sensors; determine when a hazardous condition is occurring or likely to occur; and direct the communication transmitter to send warning signals to predetermined recipients.
